(19) United States
(12) Patent Application Publication
(10) Pub. No.: US 2023/0090804 A1
(43) Pub. Date: Mar. 23, 2023

(54) IMAGE FORMING DEVICE, CONTROL METHOD THEREOF, AND IMAGE FORMING SYSTEM

(71) Applicant: SHARP KABUSHIKI KAISHA, Sakai City (JP)

(72) Inventor: Masaya ISHIHARA, Sakai City (JP)

(21) Appl. No.: 17/944,977

(22) Filed: Sep. 14, 2022

(30) Foreign Application Priority Data
Sep. 15, 2021 (JP) 2021-150074

(51) Int. Cl. G06F 3/12

(52) U.S. Cl. CPC G06F 3/1236; G06F 3/1203; G06F 3/1288; G06F 3/1293

(57) ABSTRACT

An image forming device connected to a terminal device, the image forming device includes a recognition information receiver that receives recognition information that is unique information of the terminal device from the terminal device, a storage that stores the recognition information received by the recognition information receiver, and a determiner that compares the recognition information received by the recognition information receiver with the recognition information stored in the storage to determine whether the received recognition information is stored in the storage, wherein, if when the determiner determines that the received recognition information is not stored in the storage, the image forming device performs guidance processing that notifies operation contents in the terminal device.

### CROSS-REFERENCE TO RELATED APPLICATION

The present application claims priority from Japanese Application JP 2021-150074, the content of which is hereby incorporated by reference into this application.

### BACKGROUND OF THE INVENTION

### Field of the Invention

The present disclosure relates to an image forming device that is capable of printing a document or the like on paper and is connected to a terminal device, a control method thereof, and an image forming system.

### Description of the Related Art

An image forming device, such as a copier, a facsimile machine, a printer, or the like, is connected with a plurality of terminal devices, such as, for example, personal computers or the like, via a network and thus is used in some cases. Each user performs an operation of creating a document or like operation using his or her own personal computer, and then, performs an operation of sending data from a terminal device to an image forming device and sending a print instruction to cause the image forming device to print the document.

Thus, in order to link the image forming device and the terminal device, it is necessary to download software, such as a printer driver or the like, to the terminal device so that the image forming device and the terminal device can operate in conjunction with each other. It is also desirable that the user can download information or the like useful to the user, such as a manual on how to operate the image forming device or the like, how to operate the terminal device when the user uses the image forming device, or the like, to the terminal device and can easily use the information or the like. In general, such information or the like is provided by a manufacturer of the image forming device, or the like, and the user uses the information by operating his or her own terminal device to download the information from a predetermined site or the like by himself or herself.

However, for example, in a case where a plurality of employees in a company use their own terminal devices to use an image forming device, some of the employees who are users of the image forming device lack knowledge of how to download such necessary software or the like and how to use maintenance services provided by the manufacturer of the image forming device, and many of them do not understand necessity of downloading the software. For example, in a company or the like, in a case where a person in charge (administrator) is assigned to grasp use of the image forming device or the like and to manage a system of the image forming device and the terminal devices and a new terminal device is additionally installed to the image forming device, the administrator performs setting of the terminal device by downloading necessary software for the terminal device or like operation to link the image forming device and the terminal device and, in a case where a defect occurs, the administrator handles and restores the defect, or the like. This allows each user to use the image forming device without knowledge or the like about use of the image forming device.

However, if the administrator has to perform all administrative tasks required to link the image forming device and the terminal devices for use, a problem arises in which a burden on the administrator becomes too large. In general, the administrator has other duties that he or she is in charge of, in addition to the tasks to link the image forming device and the terminal devices for use, performs the administrative tasks concurrently with other duties, and therefore, the other duties than the administrative tasks are interfered in some cases.

In addition, in a company that does not have any assigned administrator, there is another problem in which maintenance services of the manufacturer of the image forming device or the like are used, so that maintenance service fees increase. Moreover, still another problem arises in which handling by such maintenance services cannot be quickly done in some cases, and therefore, use of the maintenance services is inefficient.

For example, various technologies in which, when an information processing device, such as an MFP or the like, is replaced with a new one, or when an information processing device already in use is replaced with a replacement and the replacement is used, setting value data or the like that is device information of the information processing device before replacement is stored in advance and new settings are made using the setting value data are disclosed (for example, Japanese Unexamined Patent Application Publication No. 2014-225820). This eliminates a need to manually input new set value data into the information processing device and allows for an efficient setting operation.

However, for security reasons, it is preferable that the user or the administrator manually downloads software, such as a printer driver or the like, to the terminal device in order to link the image forming device and a terminal device or downloads a manual for an operation method and other information useful to the user to the terminal device. However, if such an operation is manually performed, the problems described above will occur. That is, it is difficult for a user with limited knowledge about necessity of downloading software or the like to perform the operations described above, and if the administrator is to perform all the operations, the burden on the administrator becomes too large. In addition, in a case where the maintenance services of the manufacturer of the image forming device or the like are used, there are problems of increased maintenance service fees, reduced efficiency, or the like.

An aspect of the present disclosure is to provide an image forming device, a control method thereof, and an image forming system that allow more smooth connection to and thus linking with a terminal device.

### SUMMARY OF THE INVENTION

An image forming device according to an aspect of the present disclosure is connected to a terminal device and includes a recognition information receiver that receives recognition information that is unique information of the terminal device from the terminal device, a storage that stores the recognition information received by the recognition information receiver, and a determiner that compares the recognition information received by the recognition information receiver with the recognition information stored in the storage to determine whether the received recognition information is stored in the storage, and, when the determiner determines that the received recognition information is not stored in the storage, the image forming device performs guidance processing that notifies operation contents in the terminal device.

Thus, according to the image forming device described above, based on the recognition information that is information unique to the terminal device, existence of a terminal device corresponding to recognition information that is not stored is determined, and guidance processing that notifies the operation contents in the terminal device is performed. Thus, when a new terminal device is additionally connected to the image forming device, the operation contents are notified, so that a user can easily recognize a necessary operation and can perform the operation efficiently.

The image forming device described above may include a display, and, if the determiner determines that the received recognition information is not stored in the storage, the image forming device may perform the guidance processing by displaying the operation contents by the display.

Thus, when the new additional terminal device is additionally connected to the image forming device, the operation contents are displayed on the display of the image forming device, so that the user can easily recognize the necessary operation by recognizing the display and can perform the operation efficiently.

The image forming device described above may include a management transmitter that transmits management information to a management terminal device included as the terminal device, and, if the determiner determines that the received recognition information is not stored in the storage, the image forming device may perform the guidance processing by transmitting the operation contents as the management information to the management terminal device by the management transmitter.

Thus, when the new terminal device is additionally connected to the image forming device, the operation contents are transmitted to the management terminal device, so that an administrator that is a user of the management terminal device can easily recognize that the new terminal device has been connected to the image forming device, can further easily recognize a necessary operation, and can perform the operation efficiently.

The image forming device described above may include an instruction signal transmitter that transmits an instruction signal to the terminal device, and, if the determiner determines that the received recognition information is not stored in the storage, the image forming device may perform the guidance processing by transmitting the operation contents as the instruction signal to the terminal device corresponding to the recognition information that is not stored in the storage.

Thus, the user of the new terminal device additionally connected to the image forming device can recognize the operation contents, can easily recognize a necessary operation, and can efficiently perform the operation.

An image forming system according to another aspect of the present disclosure includes a terminal device and an image forming device connected to the terminal device to be linked to the terminal device, and, when a new terminal device is additionally connected to the image forming device, the image forming system detects that the new terminal device has been connected to the image forming device, based on recognition information that is unique information of the terminal device, and notifies operation contents in the new terminal device.

As described above, according to the image forming system described above, the system detects that the new terminal device has been connected to the image forming device, based on the recognition information that is information unique to the terminal device and notifies the operation contents in the new terminal device. Thus, when the new terminal device is additionally connected to the image forming device, the image forming system notifies the operation contents in the new terminal device, and therefore, the user can easily recognize a necessary operation and can perform the operation efficiently.

In the image forming system described above, when a new terminal device is additionally connected to the image forming device, the image forming device may detect that the new terminal device has been connected to the image forming device, based on recognition information that is unique information of each of the terminal devices, and the image forming device that has detected that the new terminal device had been connected to the image forming device may notify the operation contents.

Thus, when the new terminal device is additionally connected to the image forming device, the image forming device notifies the operation contents, and therefore, the user can easily recognize a necessary operation by the image forming device and can perform the operation efficiently.

The image forming system described above, when a new terminal device is additionally connected to the image forming device, the image forming device may detect that the new terminal device has been connected to the image forming device, based on recognition information that is unique information of each of the terminal devices, and the image forming device that has detected that the new terminal device had been connected to the image forming device may transmit management information that instructs to notify the operation contents to the management terminal device included as the terminal device.

Thus, when the new terminal device is additionally connected to the image forming device, the image forming device instructs the management terminal device to notify the operation contents, so that the administrator that is the user of the management terminal device can easily recognize that the new terminal device has been connected to the image forming device, further can easily recognize a necessary operation, and can perform the operation efficiently.

In the image forming system described above, when a new terminal device is additionally connected to the image forming device, the image forming device may detect that the new terminal device has been connected to the image forming device, based on recognition information that is unique information of each of the terminal devices, the image forming device that has detected that the new terminal device had been connected to the image forming device may transmit an instruction signal that instructs to notify the operation contents to the new terminal device additionally connected to the image forming device, and the new terminal device additionally connected to the image forming device and has received the instruction signal may notify the operation contents.

Thus, when the new terminal device is additionally connected to the image forming device, the new terminal device connected to the image forming device notifies the operation contents, and therefore, the user of the new terminal device connected to the image forming device can recognize the operation contents, can easily recognize a necessary operation, and can perform the operation efficiently.

A method for controlling an image forming device according to an aspect of the present disclosure is a control method for controlling an image forming device connected to a terminal device and includes receiving recognition information that is unique information of the terminal device from the terminal device, comparing the received recognition information with the recognition information stored in the image forming device to determine whether the received recognition information is stored, notifying operation contents in the terminal device if it is determined that the received recognition information is not stored, and storing the received recognition information if it is determined that the received recognition information is not stored.

As described above, according to the method for controlling the image forming device, the image forming device determines whether the recognition information that is unique information of the terminal device is stored to determine existence of the new terminal device additionally connected, notifies the operation contents in the terminal device, and performs control such that the recognition information of the terminal device is stored. Thus, when a new terminal device is additionally connected to the image forming device, the operation contents are notified, so that a user can easily recognize a necessary operation and can perform the operation efficiently. Since the recognition information of the terminal device is stored, the operation contents are not notified for a next time.

According to an aspect of the present disclosure, it is possible to provide an image forming device, a control method thereof, and an image forming system that allow more smooth connection to and thus linking with a terminal device.

### BRIEF DESCRIPTION OF THE DRAWINGS

FIG. 1 is a schematic diagram illustrating a configuration of an image forming system according to a first embodiment of the present disclosure.

FIG. 2 is a perspective view illustrating an external schematic configuration of an image forming device according to the first embodiment of the present disclosure.

FIG. 3 is a block diagram schematically illustrating a control configuration of the image forming device according to the first embodiment of the present disclosure.

FIG. 4 is a view illustrating an example of a display image in a terminal device according to the first embodiment of the present disclosure.

FIG. 5 is a flowchart illustrating an example of a control operation of the image forming device according to the first embodiment of the present disclosure.

FIG. 6 is a view illustrating an example of a display presentation in an image forming device according to a second embodiment of the present disclosure.

FIG. 7 is a flowchart illustrating an example of the control operation of the image forming device according to the second embodiment of the present disclosure.

FIG. 8 is a flowchart illustrating an example of a control operation of an image forming device according to a third embodiment of the present disclosure.

### DETAILED DESCRIPTION OF THE INVENTION

With reference to the accompanying drawings, embodiments according to an aspect of the present disclosure will be described below.

### First Embodiment

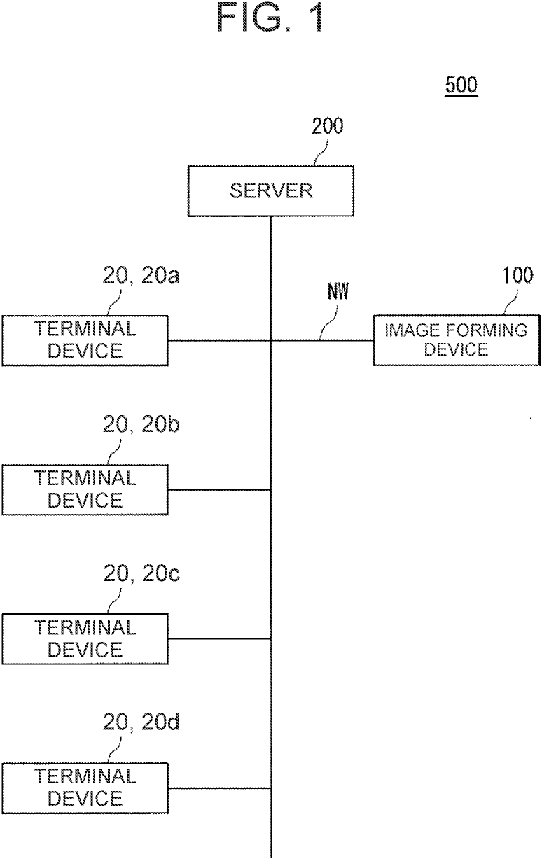

FIG. 1 is a schematic diagram illustrating a configuration of an image forming system according to a first embodiment of the present disclosure.

As illustrated in FIG. 1, an image forming system 500 includes an image forming device 100, a plurality of terminal devices 20 (20a, 20b, 20c, and 20d), and a server 200 that is an external web server. The terminal devices 20 are, for example, personal computers, and each of a plurality of users uses a corresponding one of the terminal devices 20 to perform operations, such as creating a document or the like. The plurality of terminal devices 20, that is, a terminal device 20a, a terminal device 20b, a terminal device 20c, and a terminal device 20d, and the image forming device 100 are connected to each other via a network NW to construct a local area network (LAN). In addition, the terminal device 20a is the terminal device 20 used by an administrator of the LAN and is a management terminal device. Note that the administrator of the LAN, unlike users of the other terminal devices 20, has an authority to, for example, perform settings in the LAN or the like, to manage the LAN or the like. Moreover, it is set in the image forming device 100 that the terminal device 20a is the terminal device of the administrator. That is, the terminal device 20a is set as a management terminal device in the image forming device 100.

Although, in the first embodiment, the image forming device 100 is connected to each of the four terminal devices 20, that is, the terminal device 20a, the terminal device 20b, the terminal device 20c, and the terminal device 20d, via the network NW, the number of terminal devices 20 connected to the image forming device 100 is not limited to four, may be one, and may be a plural number other than four. Each of the terminal device 20 may be a laptop computer, a tablet computer, or a smartphone. The terminal device 20 may be connected to the image forming device 100 via the network NW to execute operations, such as printing or the like, on the image forming device 100.

The user creates a document or the like using the terminal device 20 and sends an instruction to the image forming device 100 from the terminal device 20 to cause the image forming device 100 to execute printing of the created document. At this time, an electronic file that is print data of a document or the like is transmitted from the terminal device 20 to the image forming device 100, and the image forming device 100 executes printing, based on the electronic file. The user may create an electronic file using some other device that is not connected to the network NW than the terminal device 20 and send the created electronic file from terminal device 20 to the image forming device 100 to execute printing.

The image forming device 100 and the terminal devices 20 are also connected to the server 200 via the network NW. The server 200 is connected to the terminal devices 20 and the image forming device 100 via network NW and can transmit and receive data to and from each of the terminal devices 20 and the image forming device 100. The server 200 can also individually transmit and receive data to and from each of the terminal device 20a, the terminal device 20b, the terminal device 20c, and the terminal device 20d in the terminal devices 20. The server 200 is operated, for example, by the manufacturer of the image forming device 100 and allows the user to download software or the like necessary for using the image forming device 100 and to obtain useful information, such as an operation manual or the like, for using the image forming device 100 via the server 200.

Next, with reference to the accompanying drawings, the image forming device 100 will be described.

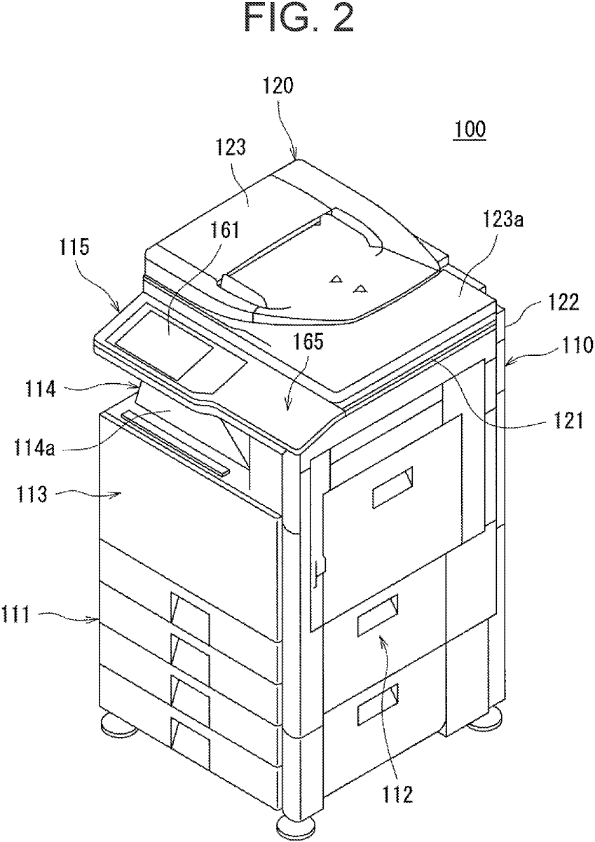

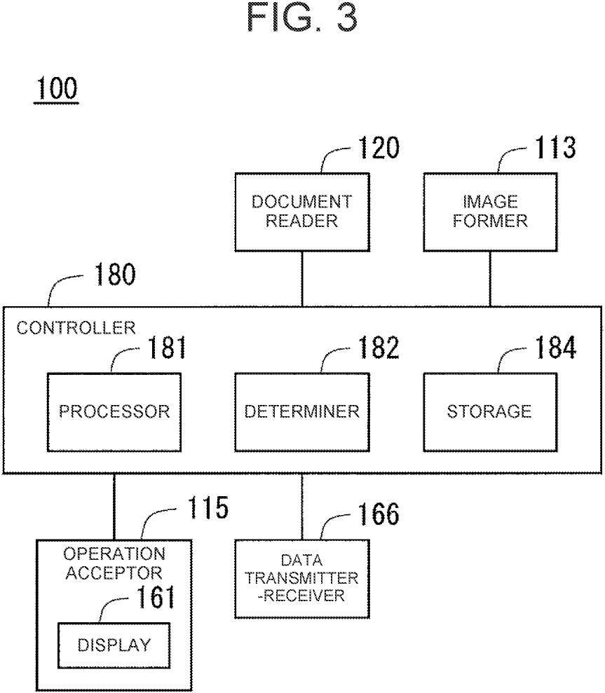

FIG. 2 is a perspective view illustrating an external schematic configuration of an image forming device according to the first embodiment of the present disclosure. FIG. 3 is a block diagram schematically illustrating a control configuration of the image forming device according to the first embodiment of the present disclosure.

As illustrated in FIG. 2, the image forming device 100 includes an image forming device main body 110 and a document reading device 120.

The document reading device 120 is provided on top of the image forming device main body 110 and includes a document mounting table 121, a document reader 122, and an automatic document feeder 123. The document reading device 120 reads an image of a document placed on the document mounting table 121 by the document reader 122 or reads an image of a document automatically fed by the automatic document feeder 123 by the document reader 122, and transmits image data of the document that has been read to the image forming device main body 110. The document reading device 120 ejects the document that has been fed by the automatic document feeder 123 and read by the document reader 122 to a document ejection tray 123a.

The image forming device main body 110 includes a sheet container 111, a sheet transporter 112, an image former 113, a sheet ejector 114, and an operation acceptor 115. The image forming device main body 110 accommodates paper that is a recording sheet, such as recording paper or the like, in the sheet container 111, transports the paper accommodated in the sheet container 111 by the sheet transporter 112, forms a color or monochrome image on the paper transported by the sheet transporter 112, based on image data transmitted from the document reading device 120 or outside by the image former 113, and ejects the paper on which the image has been formed by the image former 113 into a sheet ejection tray 114a in the sheet ejector 114. The image former 113 can also print a document or the like on paper, based on an electronic file that is print data transmitted from outside.

The sheet container 111 includes a plurality of paper cassettes each of which contains a different type of paper. For example, different sizes of paper, such as A4 size paper, A3 size paper, or the like, unused paper, paper that has been used on one side, that is, so-called back paper, or the like, are accommodated separately in the plurality of paper cassettes.

The operation acceptor 115 includes a display 161 and an operation acceptor 165. The display 161 is a touch panel display and not only displays images related to operations but also allows input by touching a screen of the display 161. The display 161 can also display a preview of a document, an image, or the like that is to be printed. The display 161 can also display communication items, informational items, or the like to the user. For example, when the user goes to retrieve a sheet of paper (printed paper) on which an image has been formed by the image forming device 100 and ejected into the sheet ejection tray 114a, or when the user goes near the image forming device 100 to make a copy of a document, the user recognizes a display presentation on the display 161 and responds to the display presentation. Although not illustrated, in the operation acceptor 165, an operation acceptor, such as a soft keyboard or like, is provided, and the user can operate the image forming device 100 via the operation acceptor 165.

The image forming device 100 further includes, in addition to the components described above, a controller 180 and a data transmitter-receiver (recognition information receiver and instruction signal transmitter) 166, as illustrated in FIG. 3.

The data transmitter-receiver 166 transmits and receives data to and from outside of the image forming device 100. The data transmitter-receiver 166 transmits and receives data to and from the outside, for example, by receiving an operation instruction, such as a print instruction from the terminal device 20 or the like, downloading software or the like necessary for operation from the server 200, transmitting a notification signal to the terminal device 20 in an event of trouble, or the like. As will be described in detail below, the data transmitter-receiver 166 receives a MAC address (recognition information) that is information unique to each of the terminal devices 20 from each of the terminal devices 20. Furthermore, the data transmitter-receiver 166 transmits a signal to the terminal device 20 to instruct to perform an operation for guiding the user to download software that enables the terminal device 20 to link with the image forming device 100, an operation manual for the image forming device 100, or the like. The data transmitter-receiver 166 may also send an e-mail to each of the terminal devices 20.

The controller 180 includes a processor 181 formed of a microcomputer, such as a central processing unit (CPU) or the like, a determiner 182 (determiner), a read only memory (ROM), a random access memory (RAM), and a storage 184 (storage) including a storage device, such as a data-rewritable nonvolatile memory or the like.

The processor 181 loads a control program stored in the ROM of the storage 184 in advance onto the RAM of the storage 184 and executes the control program to perform operation control of various components. The RAM of the storage 184 provides a work area for operation and an area as image memory in which image data is stored to the processor 181. The storage 184 stores the MAC address that is information unique to each of the terminal devices 20 connected to the image forming device 100 via the network NW. Herein, the MAC address is a number assigned to a network device, such as a personal computer or the like, and in principle, and is not duplicated for each device. That is, different MAC addresses are assigned to the terminal device 20a, the terminal device 20b, the terminal device 20c, and the terminal device 20d. The MAC address of each of the terminal devices 20 is collected by the image forming device 100 and is stored in the storage 184 when each of the terminal devices 20 is connected to the image forming device 100 via the network NW to access the image forming device 100. For example, when the terminal device 20 transmits a signal, such as a print instruction or the like, to the image forming device 100, the MAC address of the terminal device 20 is also transmitted to the image forming device 100. If, in addition to the MAC address, there is some other information unique to each of the terminal devices 20, the information may be used.

The determiner 182 determines whether the terminal device 20 having a MAC address that is not stored in the storage 184 is connected to the image forming device 100 by comparing the MAC address of each of the terminal devices 20 stored in the storage 184 with the MAC addresses of the terminal devices 20 received by the data transmitter-receiver 166. This allows the image forming device 100 to detect the terminal device 20 that is connected to the image forming device 100 for the first time. If the determiner 182 determines that the MAC address of the terminal device 20 received by the data transmitter-receiver 166 is not stored in the storage 184 (if the MAC address that is not stored in the storage 184 is detected), the determiner 182 transmits an instruction to the processor 181.

When the processor 181 receives an instruction indicating that the MAC address that is not stored in the storage 184 has been detected from the determiner 182, the processor 181 causes the data transmitter-receiver 166 to transmit an instruction signal that instructs the terminal device 20 corresponding to the MAC address to notify operation contents used for linking the image forming device 100 and the terminal device 20 (guidance processing).

The instruction signal transmitted from the image forming device 100 to the terminal device 20 specifically has a content that instructs the display device of the terminal device 20 to perform display to prompt the user to download the printer driver or the like required for linking with the image forming device 100, to download a manual on how to operate the image forming device 100, or the like. The terminal device 20 that has received the instruction signal described above from the image forming device 100 performs the above-described display on the display device, although not illustrated.

Herein, when the user uses the terminal device 20 to log in to LAN in the image forming system 500, the user opens a login screen used for entering a login name and a password required for login and enters the login name and the password. This allows the user to use the image forming device 100 using the terminal device 20. The login screen will be described using the accompanying drawings.

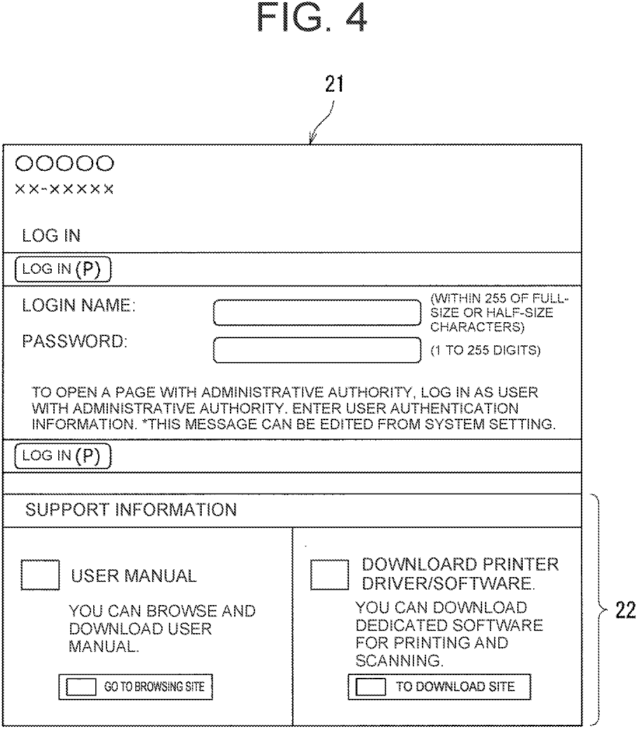

FIG. 4 is a view illustrating an example of a display image in a terminal device according to the first embodiment of the present disclosure. As illustrated in FIG. 4, in a display image 21 of the login screen, there are fields in which the user inputs a “login name” and a “password.” Furthermore, in a support information area 22 at bottom of the display image 21, a column of “SUPPORT INFORMATION” is provided and an indication that leads to a site for downloading software or the like, such as a user manual that is an operation manual for the image forming device 100, a printer driver, or the like, necessary for using the image forming device 100 with the terminal device 20 is given therein.

For example, by performing an operation by the user to select an indication of “GO TO BROWSING SITE” of “USER MANUAL” in the support information area 22, the user can be led to a site for downloading an operation manual, such as a user manual or the like. In addition, by performing an operation by the user to select an indication of “GO TO DOWNLOAD SITE” of “PRINTER DRIVER/SOFTWARE DOWNLOAD” in the support information area 22, the user can be led to a site for downloading software, such as a printer driver or the like. From these sites, the user can download the printer driver or the like required to link the terminal device 20 with the image forming device 100 and the operation manual on how to operate the image forming device 100 or the like to the terminal device 20. Specifically, these can be downloaded from the server 200. By downloading the printer driver or the like to the terminal device 20, the user can use the image forming device 100 with the terminal device 20. The user can also obtain (download) an operation manual or the like used for examining details of the operation of the image forming device 100. In order to connect the terminal device 20 to the image forming device 100 and use the image forming device 100, it is preferable to first do the above-described operations.

For example, when the user connects the terminal device 20 to the LAN of the image forming system 500 for the first time, that is, when the terminal device 20 is connected to the image forming device 100 via the network NW for the first time and an access, such as an input or the like, is made, the instruction signal described above is transmitted from the image forming device 100 to the terminal device 20. When the terminal device 20 receives the instruction signal and the user operates the terminal device 20 to open the login screen to display the display image 21, the support information area 22 is displayed in a different color from a color of the other indications so that the support information area 22 stands out in the display image 21 or in some other display manner to perform display such that the support information area 22 is emphasized. To emphasize, in addition to display the support information area 22 in a different color, for example, the support information area 22 may be displayed so as to blink. In addition, in the display image 21, display to instruct by words may be performed such that a printer driver or the like is downloaded and an operation manual or the like is obtained.

Thus, the user who uses the terminal device 20 connected to the image forming device 100 for the first time recognizes that it is needed to download the printer driver or the like and to obtain the operation manual or the like and performs these operations. This eliminates needs for the administrator to instruct the user to perform operations to download the printer driver or the like and to obtain the operation manual or the like and for the administrator to download these to the terminal device 20 in advance on behalf of the user. Thus, there is no need for a user of a terminal device 20 newly added to the image forming system 500 to perform an operation, thereby reducing the burden on the administrator. In addition, the user can smoothly use the image forming device 100.

Next, a control operation of the image forming device 100 in the image forming system 500 will be described with reference to the accompanying drawings.

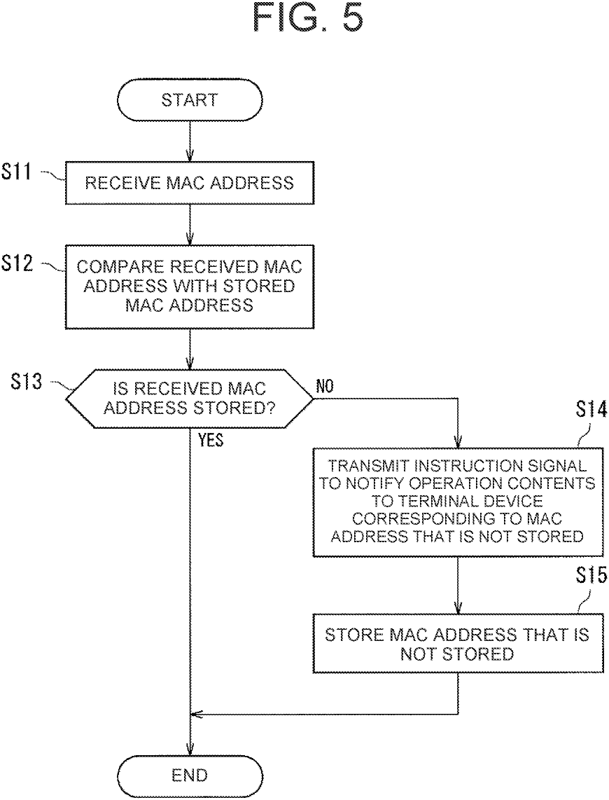

FIG. 5 is a flowchart illustrating an example of a control operation of the image forming device according to the first embodiment of the present disclosure.

In a case where, in the image forming device 100, an input is made from each of the terminal devices 20, when the image forming device 100 receives a MAC address of each of the terminal devices 20 (Step S11), each of the received MAC addresses is compared with the MAC addresses stored in the storage 184 (Step S12). As a result of the comparison, if the received MAC address is stored in the storage 184 (Step S13: YES), the operation is terminated. As a result of the comparison, if the received MAC address is not stored in the storage 184 (Step S13: NO), an instruction signal is transmitted to the terminal device 20 corresponding to the MAC address that is not stored (received MAC address) to notify operation contents (Step S14). The MAC address is then stored in the storage 184 (Step S15) and the operation is terminated.

The first embodiment has been described above. As described above, in the image forming device 100, the terminal device 20 that is connected for the first time is detected based on the MAC address of the terminal device 20 and an instruction that instructs the terminal device 20 to notify the necessary operation contents to the user is given to. The terminal device 20 that has received the instruction notifies the necessary operation contents by highlighting the necessary operation contents or like method, so that the user can recognize a necessary operation. This allows the user of the terminal device 20 to smoothly perform an operation and allows reduction of the burden on the administrator, so that the operation can be performed efficiently.

### Second Embodiment

An image forming system according to a second embodiment of the present disclosure will be described with reference to the accompanying drawings. Description of similar points to the image forming system 500 according to the first embodiment of the present disclosure will be omitted and identical parts will be denoted by the same symbol.

In the image forming system 500 according to the first embodiment of the present disclosure, when the processor 181 of the image forming device 100 receives an instruction indicating that the MAC address that is not stored in the storage 184 has been detected from the determiner 182, the processor 181 causes the data transmitter-receiver 166 to transmit an instruction signal that instructs to notify operation contents for linking to the image forming device 100 to the terminal device 20, but in the second embodiment of the present disclosure, the processor 181 that has received an instruction indicating that the MAC address that is not stored in the storage 184 has been detected from the determiner 182 causes the display 161 to display operation contents for linking the image forming device 100 and the terminal device 20 (guidance processing). Other than this point, the image forming system 500 according to the second embodiment is similar to that of the first embodiment.

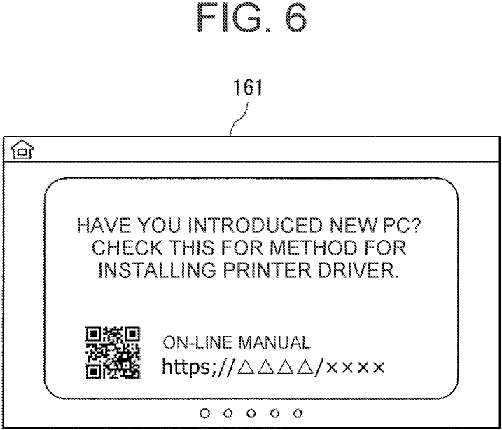

A display presentation on the display 161 will be described with reference to the accompanying drawings. FIG. 6 is a view illustrating an example of a display presentation in an image forming device according to the second embodiment of the present disclosure.

The determiner 182 determines whether the terminal device 20 having the MAC address that is not stored in the storage 184 and the image forming device 100 are connected to each other by comparing the MAC address of each of the terminal devices 20 stored in the storage 184 with the MAC address of the terminal device 20 received by the data transmitter-receiver 166 and, if the MAC address that is not stored in the storage 184 is detected, transmits an instruction to the processor 181. The processor 181 that has received the instruction instructs the display 161 to perform display illustrated in FIG. 6. Specifically, the display 161 is instructed to display contents to notify operation contents for confirming that a new terminal device 20 has been additionally connected and for linking the image forming device 100 with the terminal device 20.

In addition, by displaying a QR code (registered trademark) and a URL on the display 161, the user may browse a site for downloading software or the like, such as a user manual that is an operation manual of the image forming device 100 provided from the server 200, a printer driver or the like necessary for using the image forming device 100 with the terminal device 20, download the software, and obtain an operation manual via the terminal device 20 using the QR code and the URL. The QR code can be used by reading by a smartphone or the like.

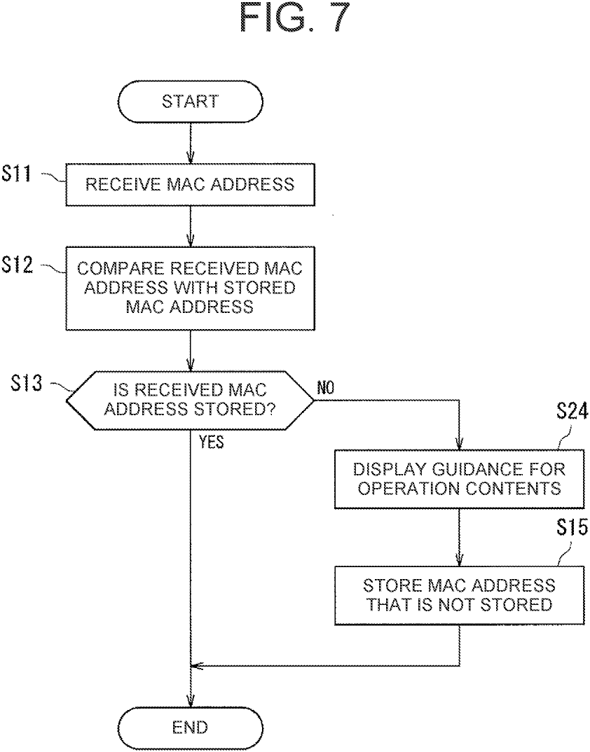

Next, the control operation of the image forming device 100 in the image forming system 500 according to the second embodiment will be described with reference to the accompanying drawings. FIG. 7 is a flowchart illustrating an example of the control operation of the image forming device according to the second embodiment of the present disclosure.

In FIG. 7, a different point of the flowchart from the flowchart illustrating an example of the control operation of the image forming device according to the first embodiment of the present disclosure in FIG. 5 is that Step S14 is replaced with Step S24. In the second embodiment, as a result of comparison of the MAC address stored in the storage 184 with the received MAC address (Step S12), if the received MAC address is not stored in the storage 184 (Step S13: NO), the display 161 performs display that notifies operation contents (Step S24), stores the MAC address in the storage 184 (Step S15), and terminates the operation. Other points than the point described above are similar to the first embodiment, and therefore, description thereof will be omitted.

The second embodiment has been described above. As described above, in the image forming device 100, the terminal device 20 that is connected for the first time is detected based on the MAC address of the terminal device 20, and display to notify operation contents necessary for the user is performed on the display 161. Thus, the user of terminal device 20 that is connected for the first time can recognize the display presentation of the display 161, thereby recognizing a necessary operation. Moreover, even the user of the terminal device 20 that is connected for the first time can recognize the display presentation of the display 161, and thus, can be prompted to perform the necessary operation for the user of the terminal device 20. This allows the user of the terminal device 20 to smoothly perform an operation and can reduce the burden on the administrator, so that the operation can be performed efficiently.

### Third Embodiment

An image forming system according to a third embodiment of the present disclosure will be described with reference to the accompanying drawings. Description of similar points to the image forming system 500 according to the first embodiment of the present disclosure will be omitted and identical parts will be denoted by the same symbol.

In the image forming system 500 according to the first embodiment of the present disclosure, when the processor 181 of the image forming device 100 receives an instruction indicating that the MAC address that is not stored in the storage 184 has been detected from the determiner 182, the processor 181 causes the data transmitter-receiver 166 to transmit an instruction signal that instructs to notify operation contents for linking with the image forming device 100 to the terminal device 20 corresponding the MAC address, but in the third embodiment of the present disclosure, the processor 181 that has received an instruction indicating that the MAC address that is not stored in the storage 184 had been detected from the determiner 182 causes the data transmitter-receiver 166 (management transmitter) to send an e-mail (management information) that notifies operation contents for linking with the image forming device 100 to the terminal device 20a that is a management terminal device (guidance processing). Other than this point, the image forming system 500 according to the third embodiment is similar to that of the first embodiment.

Contents of the e-mail sent to terminal device 20a may be, for example, a communication informing that a new terminal device 20 has been newly added to the LAN in the image forming system 500 and contents that prompt download of software or the like, such as a user manual that is an operation manual of the image forming device 100 and a printer driver or the like, necessary for using the image forming device 100 with the terminal device 20 in the new terminal device 20.

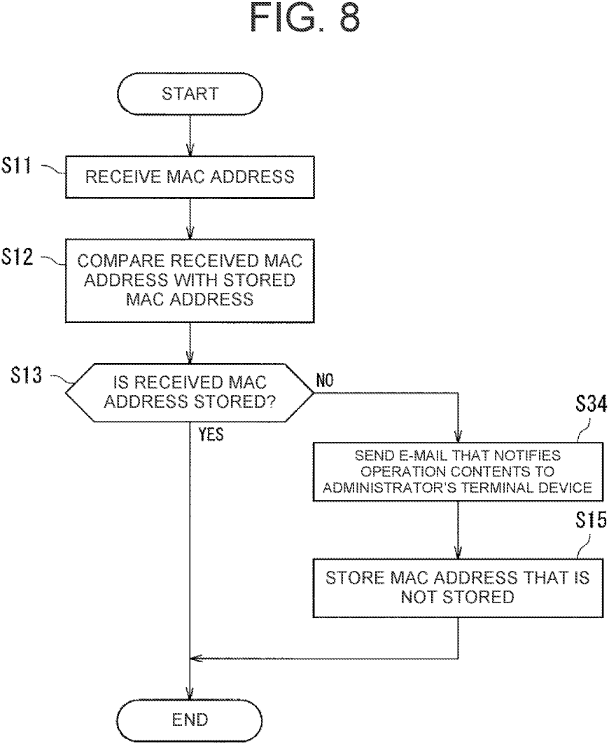

Next, a control operation of the image forming device 100 in the image forming system 500 according to the third embodiment will be described with reference to the accompanying drawings. FIG. 8 is a flowchart illustrating an example of a control operation of an image forming device according to a third embodiment of the present disclosure.

In FIG. 8, a different point of the flowchart from the flowchart illustrating an example of the control operation of the image forming device according to the first embodiment of the present disclosure in FIG. 5 is that Step S14 is replaced with Step S34. In the third embodiment, as a result of comparison of the MAC addresses stored in the storage 184 with the received MAC address (Step S12), if the received MAC address is not stored in the storage 184 (Step S13: NO), an e-mail that notifies operation contents is sent to the management terminal device (Step S34), the MAC address is stored in the storage 184 (Step S15), and the operation is terminated. Other points than the point described above are similar to the first embodiment, and therefore, description thereof will be omitted.

The third embodiment has been described above. As described above, in the image forming device 100, the terminal device 20 that is connected for the first time is detected based on the MAC address of the terminal device 20 and an e-mail that notifies necessary operation contents to the user is sent to the terminal device 20a as a management terminal device. Thus, the administrator can recognize that there is the new terminal device 20 additionally connected, thereby recognizing a necessary operation. If the user of the terminal device 20 that is connected for the first time has not performed the necessary operation, the e-mail can be forwarded to the user of the terminal device 20 that is connected for the first time to prompt the user of the terminal device 20 that is connected for the first time to perform the necessary operation. This allows the user of the terminal device 20 to smoothly perform an operation and can reduce the burden on the administrator, so that the operation can be performed efficiently.

In the above third embodiment, the image forming device 100 that has detected the terminal device 20 that is connected for the first time, based on the MAC address of the terminal device 20, sends an e-mail to the terminal device 20a, but when the administrator opens the login screen in the terminal device 20a, it is also possible to display an indication that the new terminal device 20 has been added to the LAN in the image forming system 500 and also display contents that prompt download or the like of software or the like necessary for using the image forming device 100 with the terminal device 20 as communication items.

### Other Embodiments

The first to third embodiments have been described above, but the embodiments may be performed separately, the embodiments may be performed in combination by selection, and all embodiments may be performed.

The terminal device 20 may be a smartphone or the like in addition to a personal computer. The server 200 may switch an indication of a link or the like according to the terminal device 20 that makes an access. For example, it may be determined, depending on a width of a screen resolution of the terminal device 20 that makes an access, whether the terminal device 20 is a smartphone or a personal computer, a link of a mobile app may be displayed if the terminal device 20 is a smartphone, and a link of a printer driver may be displayed if the terminal device 20 is a personal computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming device connected to a terminal device, the image forming device comprising:
a recognition information receiver that receives recognition information that is unique information of the terminal device from the terminal device;
a storage that stores the recognition information received by the recognition information receiver; and
a determiner that compares the recognition information received by the recognition information receiver with the recognition information stored in the storage to determine whether the received recognition information is stored in the storage,
wherein, when the determiner determines that the received recognition information is not stored in the storage, the image forming device performs guidance processing that notifies operation contents in the terminal device.

2. The image forming device according to claim 1, further comprising:
a display
wherein, when the determiner determines that the received recognition information is not stored in the storage, the image forming device performs the guidance processing by displaying the operation contents by the display.

3. The image forming device according to claim 1, further comprising:
a management transmitter that transmits management information to a management terminal device included as the terminal device,
wherein, when the determiner determines that the received recognition information is not stored in the storage, the image forming device performs the guidance processing by transmitting the operation contents as the management information to the management terminal device by management transmitter.

4. The image forming device according to claim 1, further comprising:
an instruction signal transmitter that transmits an instruction signal to the terminal device,
wherein, when the determiner determines that the received recognition information is not stored in the storage, the image forming device performs the guidance processing by transmitting the operation contents as the instruction signal to the terminal device corresponding to the recognition information that is not stored in the storage.

5. An image forming system comprising:
a terminal device; and
an image forming device connected to the terminal device to be linked to the terminal device,
wherein, when a new terminal device is additionally connected to the image forming device, the image forming system detects that the new terminal device is connected to the image forming device, based on recognition information that is unique information of the terminal device, and
notifies operation contents in the new terminal device.

6. The image forming system according to claim 5,
wherein, when a new terminal device is additionally connected to the image forming device, the image forming device detects that the new terminal device is connected to the image forming device, based on recognition information that is unique information of each of the terminal devices, and
the image forming device that detects that the new terminal device is connected to the image forming device notifies the operation contents.

7. The image forming system according to claim 5,
wherein, when a new terminal device is additionally connected to the image forming device, the image forming device detects that the new terminal device is connected to the image forming device, based on recognition information that is unique information of each of the terminal devices, and
the image forming device that detects that the new terminal device is connected to the image forming device transmits management information that instructs to notify the operation contents to the management terminal device included as the terminal device.

8. The image forming system according to claim 5,
wherein, when a new terminal device is additionally connected to the image forming device, the image forming device detects that the new terminal device is connected to the image forming device, based on recognition information that is unique information of each of the terminal devices,
the image forming device that detects that the new terminal device is connected to the image forming device transmits an instruction signal that instructs to notify the operation contents to the new terminal device additionally connected to the image forming device, and
the new terminal device additionally connected to the image forming device and received the instruction signal notifies the operation contents.

9. A method for controlling an image forming device connected to a terminal device, the method comprising:
receiving recognition information that is unique information of the terminal device from the terminal device;
comparing the received recognition information with the recognition information stored in the image forming device to determine whether the received recognition information is stored;
notifying operation contents in the terminal device when it is determined that the received recognition information is not stored; and
storing the received recognition information when it is determined that the received recognition information is not stored.
